(19) United States
(12) Patent Application Publication
(10) Pub. No.: US 2025/0368799 A1
(43) Pub. Date: Dec. 4, 2025

(54) PHOSPHONIUM-BASED IONIC LIQUID AND GRAPHENE FUNCTIONALIZED LAYERED DOUBLE HYDROXIDE FILLER AS A FLAME RETARDANT FOR POLYSTYRENE

(71) Applicant: KING FAHD UNIVERSITY OF PETROLEUM AND MINERALS, Dhahran (SA)

(72) Inventors: Mamdouh A. AL-HARTHI, Dhahran (SA); Mutawakkil ISAH, Dhahran (SA); Daud MUHAMMAD, Dhahran (SA); Farrukh SHEHZAD, Dhahran (SA)

(73) Assignee: KING FAHD UNIVERSITY OF PETROLEUM AND MINERALS, Dhahran (SA)

(21) Appl. No.: 18/679,850

(22) Filed: May 31, 2024

(51) Int. Cl. C08K 3/04; C08J 3/11; C08K 3/22; C08K 5/50

(52) U.S. Cl. CPC C08K 3/042; C08J 3/11; C08K 5/50; C08J 2325/06; C08K 2003/2296; C08K 2201/005; C08K 2201/006; C08K 2201/011

(57) ABSTRACT

A polymer composite including polystyrene and a filler. The filler contains a layered double hydroxide (LDH), graphene, and a phosphonium ionic liquid. The LDH includes Zn and Al. The polymer composite contains 1-20 wt. % of the filler relative to a total weight of the polymer composite. The polymer composite has higher flame-retardant properties than polystyrene alone.

### STATEMENT OF ACKNOWLEDGEMENT

Support provided by the King Fahd University of Petroleum and Minerals (KFUPM) is gratefully acknowledged.

### BACKGROUND

### Technical Field

The present disclosure is directed to a polymer composite, particularly to a polymer composite including a modified layered double hydroxide filler as a flame retardant for polystyrene.

### Description of Related Art

The “background” description provided herein presents the context of the disclosure generally. The work of the presently named inventors, to the extent it is described in this background section, as well as aspects of the description that may not otherwise qualify as prior art at the time of filing, are neither expressly nor impliedly admitted as prior art against the present invention.

Polystyrene (PS) has a wide range of applications due to its high mechanical properties. but has inherent drawbacks, such as its intrinsic flammability, significant dripping behavior, and emissions of smoke and harmful gases during combustion, which render PS unsuitable for certain applications. To achieve effective flame-inhibiting properties, one solution is to incorporate effective flame retardants into the PS matrix. Currently, the most commonly used flame retardants are halogenated compounds, specifically brominated or fluorinated compounds. However, halogen flame retardants are banned by many countries due to bioaccumulation and biotoxicity.

Layered double hydroxides (LDHs) have been introduced into polymers as nano-additives for flame retardancy due to their non-toxic nature, substantial water content, and stable layered structure. Yet a drawback with LDHs is the layered structure, potentially creating stacks upon drying and adversely affecting the mechanical properties and flame-retardant effectiveness of the polymer. To circumvent this, modification of LDH surfaces have been explored. Despite the effectiveness of LDHs as flame retardants, a challenge has been their dispersion within polymer matrices, and optimizing their compatibility limits their large-scale application. Generally, both interlayer and surface modifications of LDHs play crucial roles in advancing high-performance LDHs-based polymer matrices.

Therefore, there exists a need for an environmentally friendly modified LDH filler which can improve flame retardancy, thermal stability, thermal conductivity, and mechanical properties of the PS. It is one object of the present disclosure to describe a provide a PS composite including a modified LDH filler dispersed in the PS, thereby providing improved flame retardancy.

### SUMMARY

In an exemplary embodiment, a polymer composite is described. The polymer composite includes polystyrene and a filler. The filler contains a layered double hydroxide (LDH), graphene, and a phosphonium ionic liquid. The LDH contains Zn and Al. The polymer composite includes 1-20 wt. % of the filler, relative to a total weight of the polymer composite.

In some embodiments, the graphene is in the form of graphene nanosheets having an average size of 100-1,000 nm.

In some embodiments, the graphene nanosheets have a Brunauer-Emmett-Teller (BET) surface area of 400-600 m²/g.

In some embodiments, the graphene and the phosphonium ionic liquid are intercalated between layers of the LDH in the filler.

In some embodiments, the graphene and the phosphonium ionic liquid replace all water molecules and anions between layers of the LDH in the filler.

In some embodiments, the graphene is homogeneously dispersed in the filler.

In some embodiments, particles of the LDH have an average size of 10-70 nm.

In some embodiments, particles of the LDH have a hexagonal shape.

In some embodiments, particles of the filler have an average size of 1-20 μm.

In some embodiments, the LDH, the graphene, and the phosphonium ionic liquid do not interact through covalent bonds.

In some embodiments, the phosphonium ionic liquid contains trihexyltetradecyl phosphonium chloride.

In some embodiments, the polymer composite has a thermal stability up to 400° C.

In some embodiments, the polymer composite has a higher flame retardancy than the polystyrene alone.

In some embodiments, the polymer composite has a limiting oxygen index (LOI) of at least 19%.

In some embodiments, the polymer composite has a storage modulus greater than 2500 MPa at 50° C.

In some embodiments, the polymer composite is fluorine and bromine free.

In an exemplary embodiment, a method of forming the polymer composite is described. The method includes adding a zinc salt and an aluminum salt to form a first solution, adding the graphene and a base to form a second solution, adding a phosphonium salt to a solvent to form a third solution, adding the third solution to the second solution to form a fourth solution, adding the fourth solution to the first solution and heating for at least 12 hours to form a reaction mixture, separating the filler from the reaction mixture, and adding the filler to polystyrene to form the polymer composite.

In some embodiments, the third solution contains the phosphonium salt in an amount of 1-3 times the anion exchange capacity of the phosphonium salt.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a flow chart depicting a method of making a polymer composite, according to certain embodiments.

FIG. 1B is a schematic illustration depicting a process of making a phosphonium ionic liquid-modified layered double hydroxide (LDH), designated as ZnAl-G-PCL, according to certain embodiments.

FIG. 2 shows X-ray diffraction (XRD) patterns of a ZnAl-LDH (also referred to as ZnAl), a calcined ZnAl-LDH, a zinc-aluminum graphene (ZnAl-G) composite, and the ZnAl-G-PCL, according to certain embodiments.

FIG. 3A shows a Fourier transform infrared (FT-IR) spectrum of the ZnAl-LDH, according to certain embodiments.

FIG. 3B shows a FT-IR spectrum of the calcined ZnAl-LDH, according to certain embodiments.

FIG. 3C shows a FT-IR spectrum of the ZnAl-G composite, according to certain embodiments.

FIG. 3D shows a FT-IR spectrum of the ZnAl-G-PCL, according to certain embodiments.

FIG. 4A shows a Field Emission-Scanning Electron Microscope (FE-SEM) image of graphene, according to certain embodiments.

FIG. 4B shows a FESEM image of the ZnAl-LDH, according to certain embodiments.

FIG. 4C shows a FESEM image of the ZnAl-G, according to certain embodiments.

FIG. 4D shows a FESEM image of the ZnAl-G-PCL, according to certain embodiments.

FIG. 5A shows a High Resolution-Transmission Electron Microscopy (HR-TEM) image of the graphene, according to certain embodiments.

FIG. 5B shows a HR-TEM image of the ZnAl-LDH, according to certain embodiments.

FIG. 5C shows a HR-TEM image of the ZnAl-G, according to certain embodiments.

FIG. 5D shows a HR-TEM image of the ZnAl-G-PCL, according to certain embodiments.

FIG. 6A shows Thermogravimetric Analysis (TGA) plots of ZnAl, ZnAl-G, and ZnAl-PCL, according to certain embodiments.

FIG. 6B shows derivative TGA (dTGA) plots of ZnAl, ZnAl-G, and ZnAl-PCL, according to certain embodiments.

FIG. 6C shows TGA plots of polystyrene (PS) and PS-based nanocomposites, PS/ZnAl, PS/ZnAl-G, and PS/ZnAl-G-PCL, according to certain embodiments.

FIG. 6D shows dTGA plots of polystyrene (PS) and PS-based nanocomposites, PS/ZnAl, PS/ZnAl-G, and PS/ZnAl-G-PCL, according to certain embodiments.

FIG. 7 is a histogram including Limiting Oxygen Index (LOI) values of PS and PS-based nanocomposites PS/ZnAl, PS/ZnAl-G, and PS/ZnAl-G-PCL, according to certain embodiments.

FIG. 8A shows combustion behavior of pure PS over a period of time, according to certain embodiments.

FIG. 8B shows combustion behavior of PS-based nanocomposite, PS/ZnAl-G-PCL, over a period of time, according to certain embodiments.

FIG. 9A is a pictorial image depicting the effect of combustion on pure PS, resulting in dripping, according to certain embodiments.

FIG. 9B is a pictorial image depicting the effect of combustion on PS-based nanocomposite, PS/ZnAl-G-PCL, resulting in char formation, according to certain embodiments.

FIG. 10 is a graph depicting changes in the storage modulus of PS and PS-based nanocomposites, PS/ZnAl, PS/ZnAl-G, and PS/ZnAl-G-PCL over a range of temperatures, according to certain embodiments.

FIG. 11 is a graph depicting changes in the loss modulus of PS and PS-based nanocomposites, PS/ZnAl, PS/ZnAl-G, and PS/ZnAl-G-PCL over a range of temperatures, according to certain embodiments.

FIG. 12 is a graph depicting changes in the damping factor tan (8) of PS and PS-based nanocomposites, PS/ZnAl, PS/ZnAl-G, and PS/ZnAl-G-PCL over a range of temperatures, according to certain embodiments.

FIG. 13 is a graph depicting changes in thermal conductivity of pure PS and PS-based nanocomposites, PS/ZnAl, PS/ZnAl-G, and PS/ZnAl-G-PCL over a range of temperatures, according to certain embodiments.

### DETAILED DESCRIPTION

In the drawings, reference numerals designate identical or corresponding parts throughout the several views. Further, as used herein, the words “a,” “an,” and the like generally mean “one or more” unless stated otherwise.

Furthermore, the terms “approximately,” “approximate,” “about,” and similar terms generally refer to ranges that include the identified value within a margin of 20%, 10%, or preferably 5%, and any values there between.

Where a numerical limit or range is stated herein, the endpoints are included. Also, all values and subranges within a numerical limit or range are specifically included as if explicitly written out.

As used herein, “PS” refers to Polystyrene, LDH refers to layered double hydroxide, ZnAl-G refers to modified layered double hydroxide of Zinc-Aluminum Graphene based nanocomposite, ZnAl-G-PCL refers to modified layered double hydroxide of Zinc-Aluminum Graphene phosphonium ionic liquid-based nanocomposite.

Unless otherwise noted, the present disclosure is intended to include all isotopes of the samples used herein.

Aspects of the present disclosure are directed to a polymer composite, including a layered double hydroxide (LDH) modified with graphene (G) and a phosphonium ionic liquid for use as a flame-retardant filler for polystyrene (PS). These fillers were added to PS at varying weight percentages and were evaluated for their potential application as a flame retardant for PS. Upon the addition of the filler to the polymer composite, the polymer composite of the present disclosure demonstrates improved flame retardancy, thermal stability, thermal conductivity, and mechanical properties compared to the pure PS.

A polymer composite is described. The composite includes polystyrene and a filler. PS is a thermoplastic polymer that is in solid state at room temperature but flows if heated above about 100° C., its glass transition temperature, and becomes rigid again when cooled. PS is a highly flammable polymer; hence, fillers are added to PS to enhance its thermal stability and non-flammability. In some embodiments, the PS is atactic, syndiotactic or isotactic. In some embodiments, the PS is crystalline or amorphous. In some embodiments, the PS has a weight average molecular weight of 100,000-400,000 g/mol, preferably 150,000-350,000 g/mol, or 200,000-300,000 g/mol. In some embodiments, the filler may be used along with any other flammable polymers known in the art, for example, polypropylene or polylactide.

The filler includes a layered double hydroxide (LDH). LDHs are a class of ionic solids characterized by a layered structure with the generic layer sequence [AcBZAcB]ₙ, where c represents layers of metal cations, A and B are layers of hydroxide (HO) anions, and Z are layers of other anions and neutral molecules (such as water). Lateral offsets between the layers may result in longer repeating periods. LDHs can be seen as derived from hydroxides of divalent cations with the brucite layer structure [AdBAdB]ₙ, by oxidation or cation replacement in the metal layers (d), so as to give them an excess positive electric charge; and intercalation of extra anion layers (Z) between the hydroxide layers (A,B) to neutralize that charge, resulting in the structure [AcBZAcB]ₙ. LDHs may be formed with a wide variety of anions in the intercalated layers (Z), such as dodecyl sulfate (DDS) (CH₃(CH₂)₁₁OSO₃⁻), Cl⁻, Br⁻, nitrate (NO₃⁻), carbonate (CO₃²⁻), SO₄²⁻, acetate (C₂H₃O₂⁻), SeO₄²⁻, and combinations thereof. The size and properties of the intercalated anions may have an effect on the spacing of the layers in the LDH, known as the basal spacing. In an embodiment, the LDH has a basal spacing of 0.5 to 3 nm, preferably 1 to 2.5 nm, or 1.5 to 2 nm. In an embodiment, an LDH with an intercalated anion such as a carbonate anion, a carbonate/acetone anion, and a nitrate anion has a basal spacing of 0.5 to 1.0 nm, preferably 0.6 to 0.9 nm, or 0.7 to 0.8 nm.

An LDH may be a synthetic or a naturally occurring layered double hydroxide. Naturally-occurring layered double hydroxides include those in the Hydrotalcite Group (hydrotalcite, pyroaurite, stichtite, meixnerite, iowaite, droninoite, woodallite, desautelsite, takovite, reevesite, or jamborite), the Quintinite Group (quintinite, charmarite, caresite, zaccagnaite, chlormagaluminite, or comblainite), the Fougerite group (fougerite, trbeurdenite, or mossbauerite), the Woodwardite Group (woodwardite, zincowoodwardite, or honessite), the Glaucocerinite Group (glaucocerinite, hydrowoodwardite, carrboydite, hydrohonessite, mountkeithite, or zincaluminite), the Wermlandite Group (wermlandite, shigaite, nikischerite, motukoreaite, natroglaucocerinite, or karchevskyite), the Cualstibite Group (cualstibite, zincalstibite, or omsite), the Hydrocalumite Group (hydrocalumite or kuzelite), or may be an unclassified layered double hydroxide, such as coalingite, brugnatellite, or muskoxite.

In preferred embodiments, the layered double hydroxide has a positive layer (c) which contains both divalent and trivalent cations, also labeled as a first and second metal, respectively. In an embodiment, the divalent ion is selected from the group consisting of M²⁺ is Ca²⁺, Mg²⁺, Mn²⁺, Fe²⁺, Cu²⁺, Ni²⁺, Cu²⁺, and/or Zn²⁺. In an embodiment, the trivalent ion is selected from the group consisting of N³⁺ is Al³⁺, Mn³⁺, Cr³⁺, Fe³⁺, Sc³⁺, Ga³⁺, La³⁺, V³⁺, Sb³⁺, Y³⁺, In³⁺, Co³⁺ and/or Ni³⁺. In an embodiment, a molar ratio of a first and second metal in the LDH 2:1 to 4:1, preferably 2.4:1 to 3.8:1, preferably 2.8:1 to 3.2. In an embodiment, a molar ratio of a first and second metal in the LDH is 3:1. In a specific embodiment, the LDH includes Zn and Al. In a preferred embodiment, the LDH is a Zn—Al-LDH.

In an embodiment, the layered double hydroxide component may have a particulate form, for example in the form of spheres, granules, whiskers, sheets, flakes, plates, foils, fibers, and the like. In some embodiments, the LDH includes particles having an average size of 10-70 nm, or preferably 15-65 nm, preferably 20-60 nm, preferably 25-55 nm, preferably 30-50 nm, preferably 35-45 nm. In some embodiments, the layered double hydroxide particles are in the form of plates, or nanoplatelets due to their small size. The nanoplatelets may be substantially round or oval shaped nanoplatelets or, alternatively, the nanoplatelets may be polygonal nanoplatelets, such as triangular, square, rectangular, pentagonal, hexagonal, star-shaped, and the like. In an embodiment, the layered double hydroxide particles are in the form of hexagonal nanoplatelets with particle sizes stated above. Such nanoplatelets may have a thickness of less than 10 nm, preferably less than 8 nm, preferably less than 6 nm, preferably less than 4 nm.

The LDH is modified with graphene and a phosphonium ionic liquid. The graphene is in the form of graphene nanosheets having an average size of 100-1,000 nm, or preferably 200-900 nm, or preferably 300-800 nm, or preferably 400-700 nm, or preferably 500-600 nm. The graphene nanosheets have a BET surface area of 400-600 m²/g, or preferably 450-550 m²/g, or preferably 500-550 m²/g.

In some embodiments, the phosphonium ionic liquid can be one or more selected from tridecyl(trihexyl)phosphonium, tetradecyl(trihexyl)phosphonium, tetradecyl(trihexyl) phosphonium, tetradecyl(trihexyl)phosphonium, bis(2,4,4-trimethylpentyl)phosphinate, tetradecyl(trihexyl)phosphonium, triisobutyl(methyl)phosphonium, tributyl(methyl)phosphonium, tetradecyl(trihexyl)phosphonium, tetradecyl(trihexyl)phosphonium, tetradecyl(trihexyl)phosphonium, tributyl(methyl)phosphonium, tributyl(hexadecyl)phosphonium, tetrabutylphosphonium, tetrabutylphosphonium, tetraoctylphosphonium, tetradecyl(tributyl)phosphonium, ethyltri (butyl)phosphonium, tetradecyl(tributyl)phosphonium, tetradecyl(trihexyl)phosphonium, tetrabutylphosphonium, tri (mixed hexyl/octyl(ethyl)phosphonium), triisobutyl(methyl)phosphonium, triisobutyl(ethyl)phosphonium tosylates, triethyl(methoxyethyl)phosphonium, (trihexyl)tetradecylphosphonium, tri (i-butyl)methylphosphonium triethyl [2-(2-methoxyethoxy)ethyl] tri (i-butyl)methyl phosphonium, trihexylmethylphosphonium trihexylethylphosphonium tetrabutylphosphonium, tetrabutylphosphosphonium, (Trihexyl)tetradecylphosphonium, (Trihexyl)tetradecylphosphonium, (Trihexyl)tetradecyl phosphonium, tetrabutylphosphonium, tetrabutylphosphonium, tributylmethylphosphonium, tributylmethylphosphonium, triethylmethylphosphonium, trihexyltetradecylphosphonium trihexyl(tetradecyl)phosphonium. In a preferred embodiment, the phosphonium ionic liquid includes trihexyltetradecyl phosphonium chloride (PCL).

In some embodiments, the graphene and the phosphonium ionic liquid are intercalated between layers of the LDH in the filler. During the modification of the LDH, the graphene and the phosphonium ionic liquid replace at least 50%, 60%, 70%, 80%, 90%, or all water molecules and anions between the LDH layers. In some embodiments, the graphene is homogeneously dispersed in the filler. In some embodiments, the phosphonium ionic liquid is homogeneously dispersed in the filler. In some embodiments, particles of the filler have an average size of 1-20 μm, or preferably 5-15 μm, or preferably 12-13 μm.

In some embodiments, the filler includes 50-98 wt. % of the LDH, preferably 55-95 wt. %, 60-90 wt. %, 65-85 wt. %, or 70-80 wt. % of the LDH, 1-10 wt. % of the graphene, preferably 2-9 wt. %, 3-8 wt. %, 4-7 wt. %, or 5-6 wt. % of the graphene and 1-10 wt. % of the phosphonium ionic liquid, preferably 2-9 wt. %, 3-8 wt. %, 4-7 wt. %, or 5-6 wt. % of the phosphonium ionic liquid, based on a total weight of the filler.

The modification of the filler may be covalent or non-covalent bonds. In a preferred embodiment, the LDH, the graphene, and the phosphonium ionic liquid do not interact through covalent bonds, preferably via hydrogen bonds. In some embodiments, the polymer composite is halogen-free, preferably the polymer composite does not comprise any fluorine or bromine. In some embodiments, the PS interacts with the filler via hydrogen bonds. In some embodiments, the interactions of the PS polymer chains and filler particles form a polymer layer around each filler particle. In some embodiment, the crystallinity of the PS decreases upon addition of the filler.

The polymer composite comprises 1-20 wt. % of the filler relative to the total weight of the polymer composite, preferably 2-19 wt. %, 3-18 wt. %, 4-17 wt. %, 5-16 wt. %, 6-15 wt. %, 7-14 wt. %, 8-13 wt. %, 9-12 wt. %, or 10-11 wt. %. The polymer composite of the present disclosure demonstrates high thermal stability with up to 400° C., preferably 450° C. or at least up to 300° C. to 400° C., or preferably at least up to 250° C. to 300° C. The polymer composite also demonstrates a higher flame retardancy in comparison to the flame retardancy exhibited by polystyrene alone.

In some embodiments, the polymer composite has a storage modulus greater than 2500 MPa at 50° C., preferably 2700 MPa at 50° C., preferably 2800 MPa at 50° C., preferably 3000 MPa at 50° C., preferably 3200 MPa at 50° C., preferably 3500 MPa at 50° C. This indicates that the mechanical properties of the PS are maintained+10%, preferably +5%, after modification with the filler.

The limiting oxygen index (LOI) is the minimum concentration of oxygen in a mixture of oxygen and nitrogen needed to support the flaming combustion of a material. It is expressed in volume percent (vol %). Materials with LOI values less than 21% are classified as combustible, but those with LOI greater than 21 are classed as self-extinguishing since their combustion cannot be sustained at ambient temperature without an external energy contribution. The polymer composite of the present disclosure has a limiting oxygen index (LOI) of at least 19%, preferably 19-21%, or about 20%.

While not wishing to be bound to a single theory, it is thought that the polymer composite has improved flame retardancy properties compared to the PS alone, because the phosphorus-oxygen bond in the ionic liquid established bridging bonds with the metal ions in LDH, thereby promoting synergistic effects that facilitate char formation. Also, in the presence of air, phosphonium ionic liquids tend to generate phosphine oxides, which is not a combustible gas that can dilute the oxygen presence on the PS surface. The residual char formed during pyrolysis exhibits a dense nature that adheres to the PS surface, which leads to a reduction in heat transfer and limits the penetration of oxygen, thereby decreasing the emission of combustion gases.

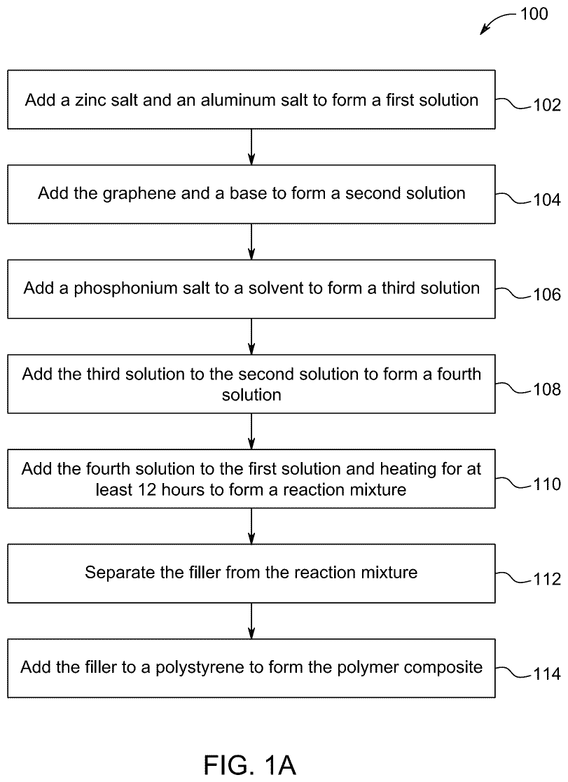

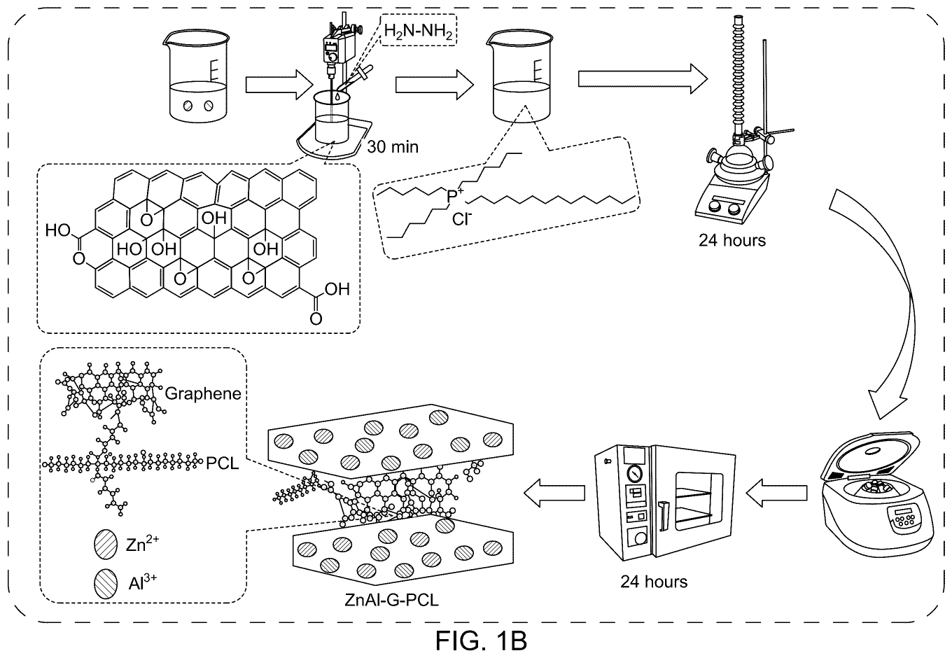

Referring to FIG. 1A, a method of making the polymer composite is described. The order in which the method 100 is described is not intended to be construed as a limitation, and any number of the described method steps may be combined in any order to implement the method. Additionally, individual steps may be removed or skipped from method without departing from the spirit and scope of the present disclosure.

At step 102, the method 100 includes adding a zinc salt and an aluminum salt to form a first solution. Suitable examples of zinc salt include sulfates, sulfites, citrates, chlorides, carbonate, phosphate, nitrates, nitrites, etc. In an embodiment, the zinc salt is a nitrate salt. Similarly, suitable examples of aluminum salt include aluminum chloride, aluminum nitrate, aluminum sulphate, etc. In a preferred embodiment, the aluminum salt is aluminum nitrate. The molar ratio of the zinc salt to the aluminum salt is in the range of 5:1 to 1:5, preferably 4:1 to 1:4, preferably 3:1 to 1:3, preferably 2:1 to 1:2, preferably 1:1. In a preferred embodiment, the molar ratio of the zinc salt to the aluminum salt is 3:1. The pH during this reaction may be in the range of 9-12, preferably 9-10, preferably 9.5. The pH may be adjusted using a suitable alkaline buffer, such as sodium hydroxide. Optionally, other buffers known to a person skilled in the art may be used as well.

The first solution includes the precursors of the Zn—Al-LDH. The metal salts selected to prepare the first solution may be changed depending on the trivalent cation and the bivalent cation desired in the LDH, and such a selection may be obvious to a person skilled in the art.

At step 104, the method 100 includes adding the graphene and a base to form a second solution. Simultaneously, the second solution can be prepared by adding graphene to a base, preferably NaOH. The dispersion of graphene in NaOH results exfoliates layers of graphene to form graphene sheets. The exfoliation process can be aided by any suitable means of agitation, such as sonication. In a preferred embodiment, the sonication may be carried out at a frequency of 40-60 Hz, preferably 50 Hz for 10-60 minutes, preferably 20 minutes, preferably 30 minutes, preferably 40 minutes, preferably 50 minutes, more preferably at about 30 minutes. The concentration of the NaOH may be in the range of 0.1-1 M, preferably 0.1-0.8 M, preferably 0.1-0.6 M, preferably 0.1-0.5 M, preferably 0.1-0.4 M, preferably 0.1-0.3 M, preferably 0.1 M. However, concentrations beyond these ranges may be used as well.

At step 106, the method 100 includes adding a phosphonium salt to a solvent to form a third solution. The phosphonium salt may be a salt of one or more phosphonium ligands as previously described. In a preferred embodiment, the phosphonium salt is trihexyltetradecyl phosphonium chloride. The phosphonium salt may be dissolved in a solvent. Suitable solvents may be methanol, ethanol, isopropanol, etc. In a preferred embodiment, the solvent is ethanol. In some embodiments, the third solution comprises the phosphonium salt in an amount of 1-3 times the anion exchange capacity of the phosphonium salt.

At step 108, the method 100 includes adding the third solution to the second solution to form a fourth solution.

At step 110, the method 100 includes adding the fourth solution to the first solution and heating for at least 12 hours to form a reaction mixture. This process results in the formation of the filler.

At step 112, the method 100 includes separating the filler from the reaction mixture. The separation may be carried out by any method known in the art, including centrifugation or filtration. After separating the filler from the reaction mixture, the filler may be dried for 8-15 hours, preferably 10-12 hours, under vacuum to prevent any further reactions/air oxidation.

At step 114, the method 100 includes adding the filler to a polystyrene to form the polymer composite. The filler thus obtained is added to polystyrene to form the polymer composite. In some embodiments, the filler is incorporated into the PS by mixing the filler into premade PS. In a preferred embodiment, the PS is heated above 100° C., preferably 100-200° C., 125-175° C. or about 150° C., when the filler is added in order to create a more malleable PS for homogeneous dispersion of the filler. In a preferred embodiment, the filler is mixed into the PS over a time of 1-60 minutes, preferably 10-50 mins, 20-40 mins or about 30 mins to homogenously disperse the filler in the PS to form the polymer composite. Following which the polymer composite can be formed into any required shape.

### EXAMPLES

The following examples demonstrate a polymer composite comprising polystyrene and a modified layered double hydroxide (LDH), as described herein. The examples are provided solely for illustration and are not to be construed as limitations of the present disclosure, as many variations thereof are possible without departing from the spirit and scope of the present disclosure.

### Example 1: Materials

All materials and chemicals utilized were used without further modifications. Aluminum nitrate nonahydrate [Al(NO₃)₃·9H₂O], zinc nitrate hexahydrate [Zn(NO₃)₂·6H₂O], trihexyltetradecyl phosphonium chloride, graphene nanosheets having a Brunauer-Emmett-Teller (BET) surface area 500 m²/g, ethanol, and other chemicals and solvents were purchased from Sigma-Aldrich Co.

### Example 2: Synthesis of ZnAl-Layered Double Hydroxide (LDH)

ZnAl-LDH was synthesized via a co-precipitation technique. Briefly, Zn(NO₃)₂·6H₂O (0.06 M) and Al(NO₃)₃·9H₂O (0.02 M) were mixed in 50 mL of deionized (DI) water in a three-necked flask (500 mL). While vigorously stirring, NaOH (1.0 M) was added dropwise to the mixture to adjust the pH to 9.5±0.1 at 60° C. Following pH stabilization, the resultant white slurry underwent reflux for 24 h at 90° C. The product was then centrifuged at 4500 rpm for 10 minutes and washed with DI water and ethanol to remove any impurities. After drying the thick suspension for 24 h in a vacuum oven at 60° C., 8.0±0.5 g of pure ZnAl-LDH was obtained. The formed ZnAl-LDH is also referred to as ZnAl throughout the disclosure. To form a calcined ZnAl-LDH, the formed ZnAl-LDH was subjected to a calcination process conducted within a nitrogen environment using a tubular furnace at 450° C. for 4 hours.

### Example 3: Synthesis of ZnAl-G Nanocomposite

A ZnAl LDH and graphene nanocomposite was synthesized utilizing a co-precipitation method and is labeled throughout as ZnAl-G and may be referred to as a composite or a nanocomposite. Initially, 300 mg of graphene underwent probe-sonication in a beaker containing 50 mL of DI water and 50 mL of 0.1 M NaOH for 30 minutes, utilizing an amplitude of 50 Hz. Subsequently, the sonicated graphene sheets and NaOH solution (1.0 M) were incrementally added to a three-necked flask containing a solution comprising 0.06 M Zn(NO₃)₂·6H₂O and 0.02 M Al(NO₃)₃·9H₂O under vigorous stirring. The pH of the mixture was adjusted to 9.5±0.1, followed by refluxing for 24 h at 90° C. The resulting slurry underwent centrifugation and was washed multiple times with DI water and ethanol, then dried for 24 hours in a vacuum oven. This process yielded approximately 9 g of the ZnAl-G composite.

### Example 4: Preparation of Phosphonium IL-Modified LDH (ZnAl-G-PCL)

A phosphonium ionic liquid (IL) modified ZnAl-G nanocomposite was synthesized and is labeled throughout as ZnAl-G-PCL and may be referred to as a composite or a nanocomposite. The synthesis of ZnAl-G-PCL, started by mixing precursor salts of Zn (0.06 M) and Al (0.02 M) in a three-necked flask. Separately, 300 mg of graphene underwent probe-sonication in a 100 mL mixture of DI water and 0.1 M NaOH for 30 minutes. Subsequently, an amount approximately twice the anionic exchange capacity (AEC) of PCL was added to 50 mL of ethanol and stirred for 30 minutes. The PCL mixture was then introduced into the graphene solution, followed by a gradual addition to the salt solution. To maintain the pH at 9.5±0.1, 1.0 M NaOH was used, and the solution underwent overnight reflux. The resulting slurry was centrifuged, washed, and subsequently dried overnight in a vacuum oven. This process yielded approximately 12 g of the ZnAl-G-PCL nanocomposite (FIG. 1B).

### Example 5: Synthesis of Polystyrene Nanocomposites

Polystyrene (PS) composites were formed by blending PS with various concentrations of ZnAl-LDH and its hybrids. The different mass fractions of ZnAl-LDH hybrids were incorporated into PS using a Brabender internal torque rheometer (Brabender Technologie GmbH & Co. KG, Duisburg, Germany) operating at 175° C. and a rotational speed of 75 rpm for 10 minutes until the torque reached stability. Subsequently, the compound was removed from the mixer while hot and compressed in a carver press at 175° C. for 5 minutes, resulting in sheets with a thickness of 3 mm. The filler was introduced into the PS blend at concentrations of 5% wt %, 10% wt, and 15% wt %. The samples were labeled as follows: PS+5% ZnAl, PS+5% ZnAl-G, PS+5% ZnAl-G-PCL, PS+10% ZnAl-G-PCL, and PS+15% ZnAl-G-PCL.

### Example 6: X-Ray Diffraction (XRD) Analysis

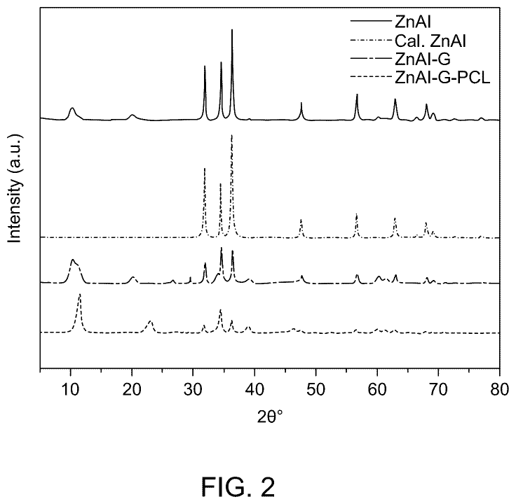

The crystallinity nature analysis of ZnAl-LDH, calcined ZnAl-LDH, ZnAl-G, and ZnAl-G-PCL was carried out via XRD technique by utilizing copper (Cu) as the X-ray generation source at 40 kV, 15 mA and 5°/min with a KalCu wavelength of 1.54059. The XRD spectrum of pristine ZnAl-LDH, calcined ZnAl-LDH, ZnAl-G, and ZnAl-G-PCL are shown in FIG. 2. The synthesized pristine ZnAl-LDH diffraction peaks were observed at around 20° values of 10°, 23°, 35°, 39°, 48°, 57°, 64° and 68° correspond to the crystallographic planes of (003), (006), (009), (015), (018), (110), (103) and (112). After calcination, the characteristic peaks of ZnAl-LDH at 10° and 23° ceased to appear on the calcined ZnAl-LDH spectra. This transformation indicates the removal of intercalated water molecules (OH⁻) and anions (NO₃⁻) from the layers of the ZnAl-LDH, which led to the shift from a layered structure to a mixed metal oxide structure, as shown in the FIG. 2. Within the zoomed-in region of ZnAl-G and ZnAl-G-PCL at approximately 2θ≈24°, the graphene peaks are visible.

### Example 7: Fourier Transform Infrared (FT-IR) Spectroscopy Analysis

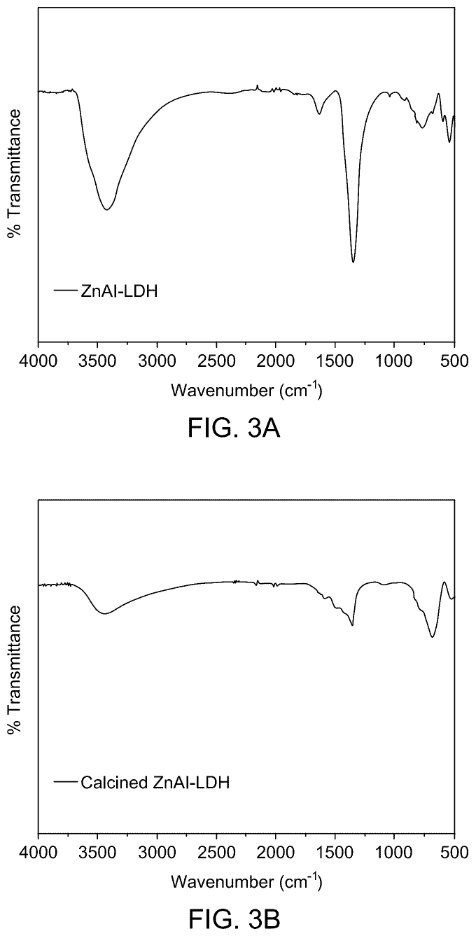

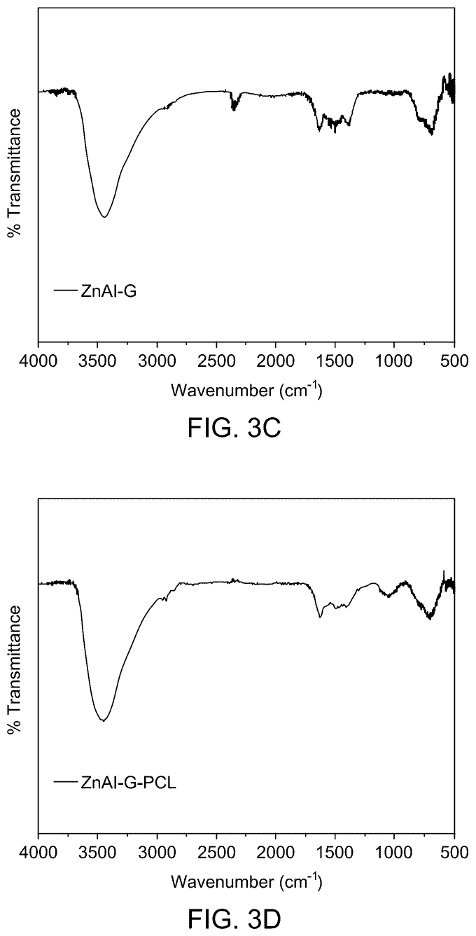

The chemical structure study of the ZnAl-LDH and the modified ZnAl-LDHs was carried out using Fourier transform infrared (FT-IR) spectroscopy analysis via a Nicolet 6700 spectrometer (Thermo-Nicolet, Japan) with a scanning range of 4000-500 cm⁻¹. FIGS. 3A-3D show the peaks of ZnAl-LDH, calcined ZnAl-LDH, ZnAl-G, and ZnAl-G-PCL, respectively. A strong and broad peak at around 1670 cm⁻¹ was observed in FIG. 3A is a sign of the bonding vibrations of the water molecules intercalated within the LDHs interlayer structures. The characteristic peaks at around 1370 cm⁻¹ are attributed to stretching vibrations of the NO₃ anion in the hydrotalcite. Moreover, the detected peaks observed at 600 cm⁻¹ and 760 cm⁻¹ belong to Zn—OH and Al—OH, respectively. However, after calcination, the characteristic peak at around 3500 cm-1 has diminished, as can depicted in FIG. 3B, indicating that the intercalated water molecules were successfully removed. The stretching vibrations at wavenumber 1450 cm⁻¹ are due to C—H in a graphene structure, which is observed in FIG. 3C, the presence of the peak at wavenumber 980 cm-1 is due to P—C as depicted in FIG. 3D Therefore, FTIR results with the XRD indicate that the synthesized ZnAl-LDH was successfully modified where graphene and phosphonium-based ionic liquid have replaced the intercalated water molecules and anion in the LDHs layers.

### Example 8: Morphological Characterization

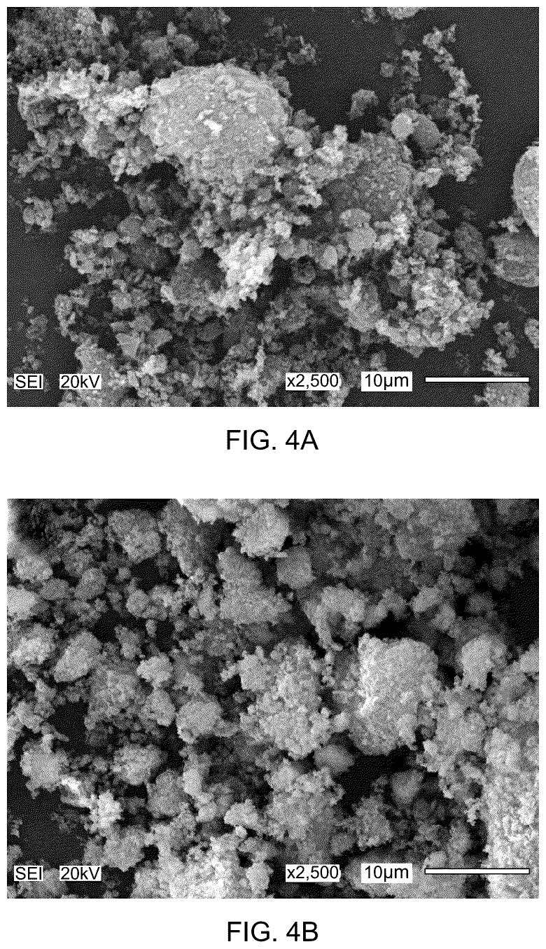

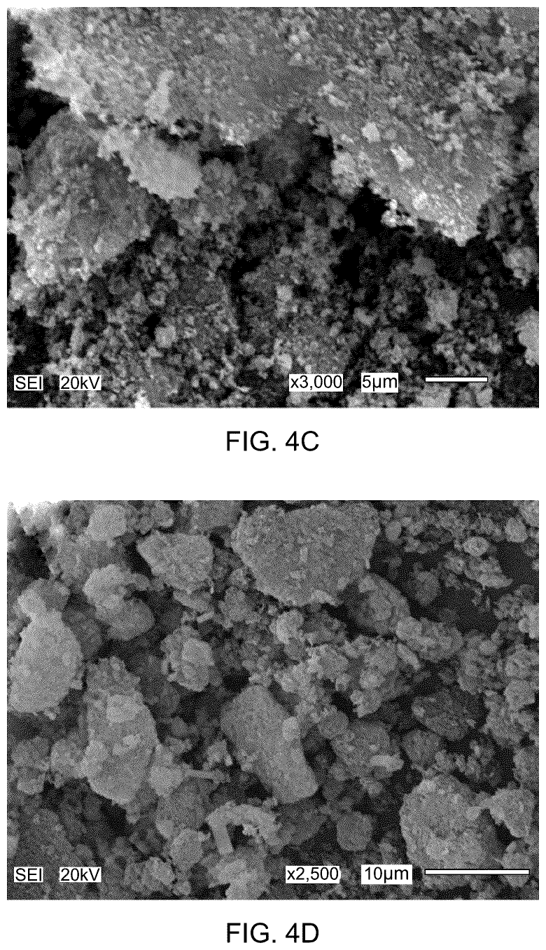

The morphological features and surface properties of the LDH and its nanocomposites underwent analysis via field emission scanning electron microscopy (FE-SEM) at various resolutions, as depicted in FIGS. 4A-4D. The graphene displayed a planar structure (FIG. 4A), contrasting with the aggregate structure observed in ZnAl-LDH (FIG. 4B). Notably, the FE-SEM images of ZnAl-G and ZnAl-G-PCL (FIG. 4C, FIG. 4D) exhibited a combination of planar and aggregate structures. These images indicated the presence of both graphene sheets and LDH within the samples.

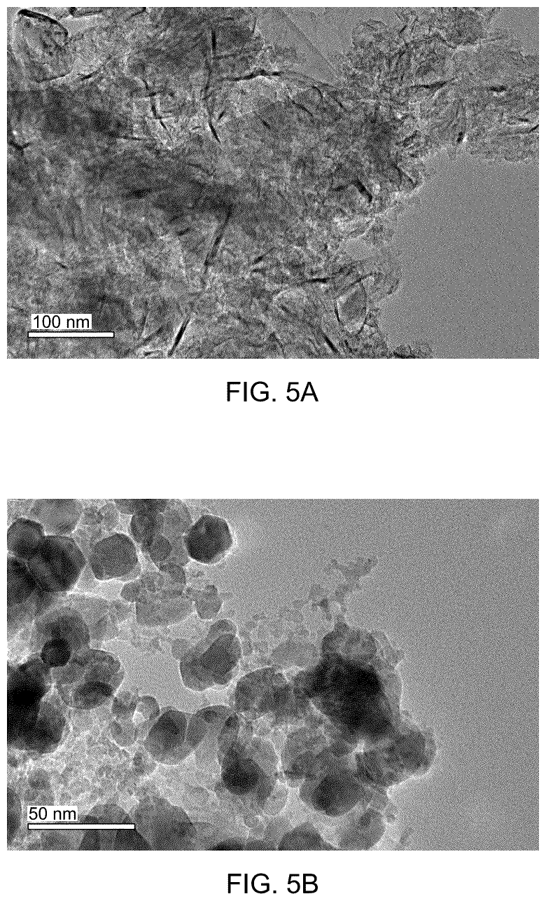

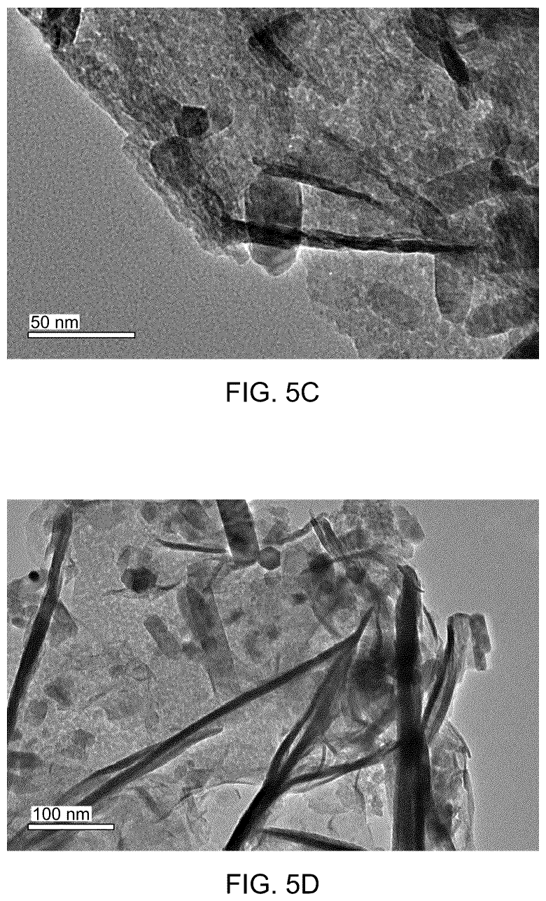

The transmission electron microscope (TEM) images presented in FIGS. 5A-5D, illustrate the structure of the LDH, and their composites. FIG. 5A shows a TEM of graphene having a wrinkled nanosheet structure. In FIG. 5B, the distinct sharp hexagonal structure of the ZnAl-LDH is apparent. Notably, in the nanocomposites comprising ZnAl-G and ZnAl-G-PCL, hexagonal structures were observed beneath the layer of graphene nanosheets. Furthermore, FIG. 5C and FIG. 5D demonstrate the homogeneous dispersion of graphene within the filler, showcasing a synergistic effect within the structure.

### Example 9: Thermal Stability Analysis

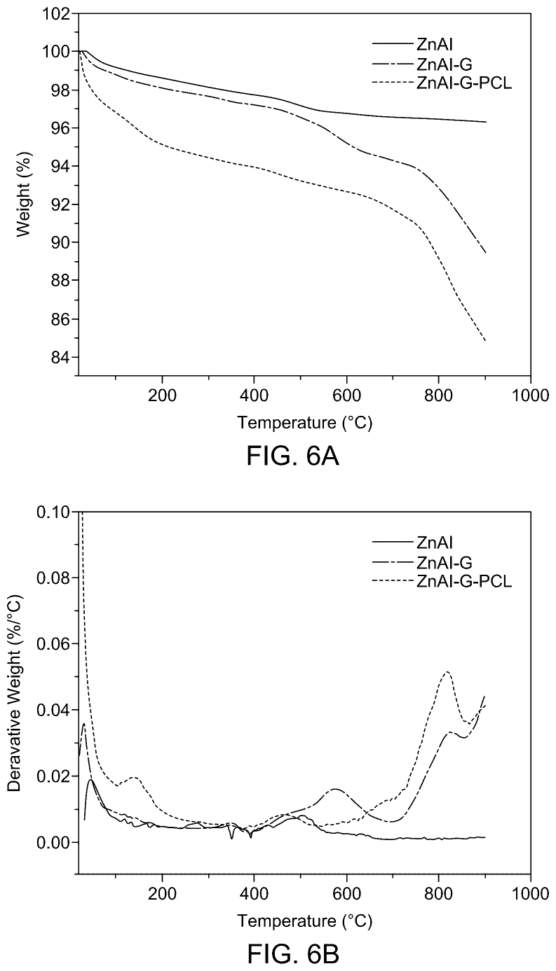

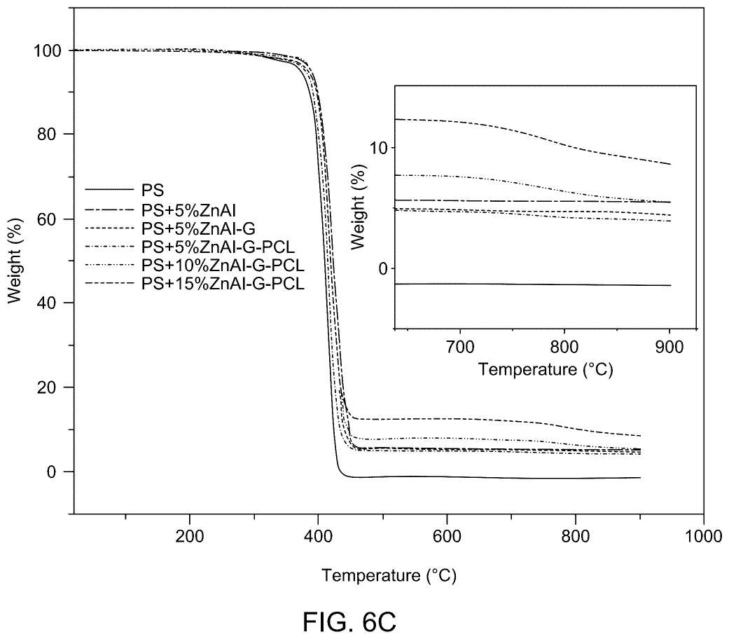

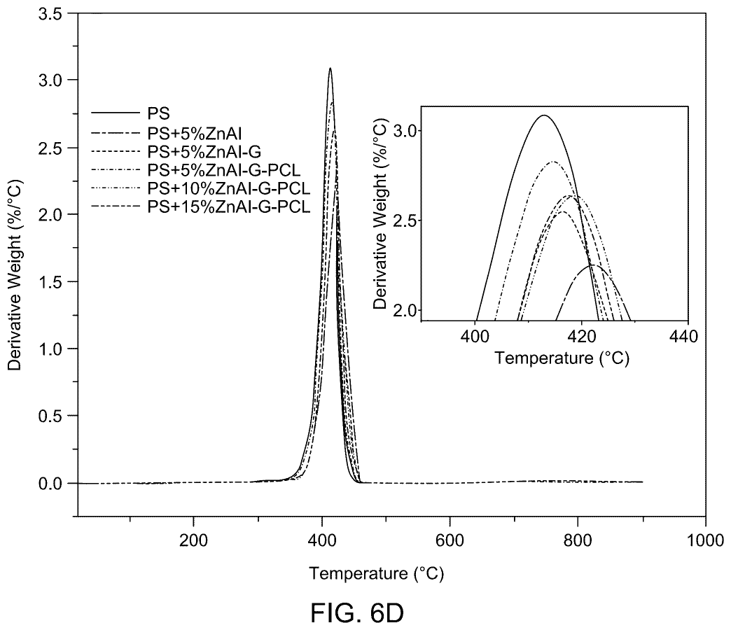

The thermal stability of ZnAl, ZnAl-G, and ZnAl-G-PCL under nitrogen flow was examined using thermogravimetry (TG) and derivative thermogravimetry (DTG), as illustrated in FIG. 6A and FIG. 6B. Notably, ZnAl-LDH pristine demonstrated higher thermal stability compared to its composite counterparts due to the strong van der Waals forces between the layers. However, intercalating graphene and ionic liquid into the interlayer of ZnAl-LDHs led to a decrease in the LDHs' thermal stability by decreasing the forces between the laminates.

ZnAl-LDH pristine displayed three primary weight-loss stages: the initial phase, occurring between 5° and 220° C., attributed to the release of physically attached water molecules on the surface and within the LDHs-C layers. Weight loss between 190-220° C. was linked to the elimination of minor quantities of —OH and NO₃⁻ resulting from electrostatic bonds. The second weight-loss stage, between 400-600° C., involved the elimination of interlayer crystallization water. The last stage resulted from the dehydroxylation and deionization processes of LDHs, with the potential transformation into a dense metal oxide as the temperature increased (600-900° C.).

The ZnAl composites followed a similar weight-loss pattern to ZnAl-LDH pristine due to released absorbed water and crystallization water molecules. In ZnAl-G, the primary weight loss stemmed from dehydroxylation, deionization of NO₃⁻, and the presence of graphene. ZnAl-G-PCL, however, exhibited a different TGA curve compared to ZnAl and ZnAl-G-LDH, indicating the lower thermal stability of metal phosphine oxides compared to the volatile anion NO₃⁻. This directly indicates the successful replacement of NO₃ of ZnAl-LDH with phosphorus from the PCL. Despite these differences, these materials still showed high thermal stability.

The fillers residues at 500° C. were measured as 97.2%, 96.55%, and 93.22% for ZnAl, ZnAl-G, and ZnAl-G-PCL, respectively, indicating their effective potential for flame retardation due to their ability to carbonize. Additionally, the weight loss at higher temperatures (700° C.) was observed at 3.41%, 5.69%, and 8.25% for ZnAl, ZnAl-G, and ZnAl-G-PCL, respectively, with maximum mass loss rates (Rₘₐₓ) of 0.01%, 0.03%, and 0.05% per° C. (Table 1). The exceptional thermal stability of ZnAl-G-PCL significantly mitigate the fire risk associated with PS.

The analysis of the thermal stability of pure PS and its composites is depicted in FIG. 6C and FIG. 6D, with specific TG, DTG values, and char yield parameters outlined in Table 1. Overall, the Table 1 illustrates a notable enhancement in PS thermal stability upon composite incorporation. For pure PS, the thermal degradation characteristics exhibited a T_{5%} (temperature at 5 wt. % weight loss) of 371° C., a Tₘₐₓ (maximum degradation rate temperature) of 413° C., and a high mass loss rate of 3.09% per° C. Beyond 430° C., the complete degradation of PS occurred, leaving no residue, signifying its relatively low thermal stability. However, upon incorporating 5 wt. % of ZnAl, ZnAl-G, and ZnAl-G-PCL into the PS matrix, there was a noticeable improvement in thermal stability.

TABLE 1
Thermal parameters of TGA and DTG curves
for ZnAl hybrids, PS, and PS composites

| | | | ^{c} Rₘₐₓ | Residue | Residue |
|---|---|---|---|---|---|
| | ^{a} T_{5%} | ^{b} Tₘₐₓ | (% per | at 500° C. | at 700° C. |
| Sample | (° C.) | (° C.) | ° C.) | (%) | (%) |
| PS | 371 | 413 | 3.09 | / | / |
| ZnAl | / | 510 | 0.01 | 97 | 96.59 |
| ZnAl-G | 616 | 829 | 0.03 | 96 | 94.31 |
| ZnAl-G-PCL | 217 | 817 | 0.05 | 93 | 91.75 |
| PS/5% ZnAl | 384 | 422 | 2.25 | 6.75 | 5.62 |
| PS/5% ZnAl-G | 380 | 417 | 2.55 | 5.50 | 5.09 |
| PS/5% ZnAl-G-PCL | 381 | 415 | 2.83 | 5.20 | 4.80 |
| PS/10% ZnAl-G-PCL | 388 | 418 | 2.64 | 9.00 | 8.02 |
| PS/15% ZnAl-G-PCL | 385 | 418 | 2.62 | 13.56 | 12.15 |

^{a} T_{5%}: thermal degradation temperature when the weight loss was 5 wt %,
^{b} Tₘₐₓ: thermal degradation temperature when the weight loss was at its maximum,
^{c} Rₘₐₓ: maximum mass loss rate.

Incorporating 5 wt. % of ZnAl, ZnAl-G, and ZnAl-G-PCL into the PS matrix notably increased the T_{5%} to 384° C., 380° C., and 381° C., respectively (FIG. 6C and FIG. 6D). Additionally, Tₘₐₓ increased to 422° C., 417° C., and 415° C. for PS/5% ZnAl, PS/5% ZnAl-G, and PS/5% ZnAl-G-PCL, respectively, indicating enhanced thermal stability due to these fillers. The improved thermal stability of pure PS was attributed to these fillers' excellent thermal properties. Moreover, a decrease in the weight-loss rate of PS composites was observed, reducing from 3.09 to 2.25, 2.55, and 2.83% per° C. for PS/5% ZnAl, PS/5% ZnAl-G, and PS/5% ZnAl-G-PCL, respectively. While pure PS yielded 0 wt % of carbonaceous residue at 500° C., the incorporation of 5 wt % of ZnAl, ZnAl-G, and ZnAl-G-PCL into the PS matrix increased the char residue to 6.75%, 5.50%, and 5.20% at 500° C., respectively. This demonstrates the effective enhancement of the carbonization process in burning PS. The introduction of ZnAl pristine generated the highest char residue, followed by ZnAl-G and ZnAl-G-PCL, owing to the robust van der Waals forces between the ZnAl-LDH laminates, enhancing its thermal stability. The intercalation of graphene and PCL ionic liquid on ZnAl-LDH decreased the forces between the laminates, promoting char formation.

### Example 10: Flame Retardancy Properties

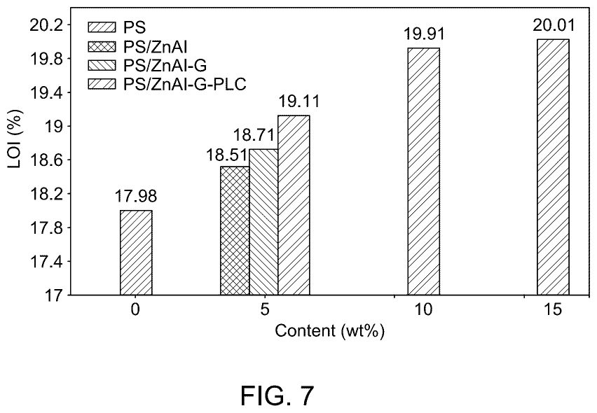

The burning behavior of PS and its composites, PS/ZnAl, PS/ZnAl-G, and PS/ZnAl-G-PCL, was examined using the LOI, which is a fundamental method employed to examine the flammability properties of polymers. The LOI values for the pure PS, PS/ZnAl, PS/ZnAl-G, and PS/ZnAl-G-PCL are depicted in FIG. 7. The initial assessment of flame resistance in PS nanocomposites centered around the LOI value. Pure PS demonstrated an LOI range of 17.98-18.0, indicating its high flammability and susceptibility to combustion in air. However, upon incorporating ZnAl-LDHs and its composites, the LOI values exhibited an increase, and no dripping was observed during burning. The addition of 5 wt. % of ZnAl, ZnAl-G, and ZnAl-G-PCL led to LOI value increments of 18.51, 18.71, and 19.11, respectively (FIG. 7). Consequently, the introduction of LDH nanocomposites enhanced the burning behavior of PS in comparison to its pure form.

Pure PS exhibits continuous burning akin to a candle, with a consistent flow of melting drips until complete depletion. the combustion behavior of PS/ZnAl nanocomposites revealed distinct surface characteristics. These samples showcased three discernible regions: skin layers comprised of char, followed by molten layers atop a solid surface. Considering the LDH loading level at 5 wt. %, the highest increase in LOI value was observed for ZnAl-G-PCL, followed by ZnAl-G, and then ZnAl. This trend is connected to the intercalation of graphene and PCL ionic liquid within the ZnAl-LDH interlayers. Moreover, upon incorporating 10 wt. % and 15 wt. % of ZnAl-G-PCL with PS, the LOI values increased to 19.91 and 20.01, respectively.

Consequently, the modification of ZnAl-LDHs positively influences pure PS, leading to alterations in the LOI values of PS nanocomposites. This effect was attributed to the reduced oxygen content caused by the presence of phosphorus-oxygen bonds in ZnAl-G-PCL-LDH, which is lower compared to ZnAl-G and ZnAl. The phosphorus-oxygen bond contributed to enhancing flame retardancy by establishing bridging bonds with the metal ions in LDH, thereby promoting synergistic effects that facilitate char formation. Also, in the presence of air, PCL tends to generate phosphine oxides, which is not a combustible gas that can dilute the oxygen presence on the PS surface. The residual char formed during pyrolysis exhibits a dense nature that adheres to the polymer's surface. This adherence leads to a reduction in heat transfer and limits the penetration of oxygen, thereby decreasing the emission of combustion gases. As a consequence, pure PS ignites rapidly, propagating fire swiftly and generating molten drips without significant self-extinguishing behavior. In contrast, PS composites show a distinct behavior, lacking the generation of molten droplets during combustion and exhibiting self-extinguishing properties. The most effective flame-retardant materials are those capable of self-extinguishing shortly after ignition, producing minimal smoke throughout combustion. Notably, the addition of ZnAl-G-PCL significantly enhanced the flame-retardant characteristics of PS composites.

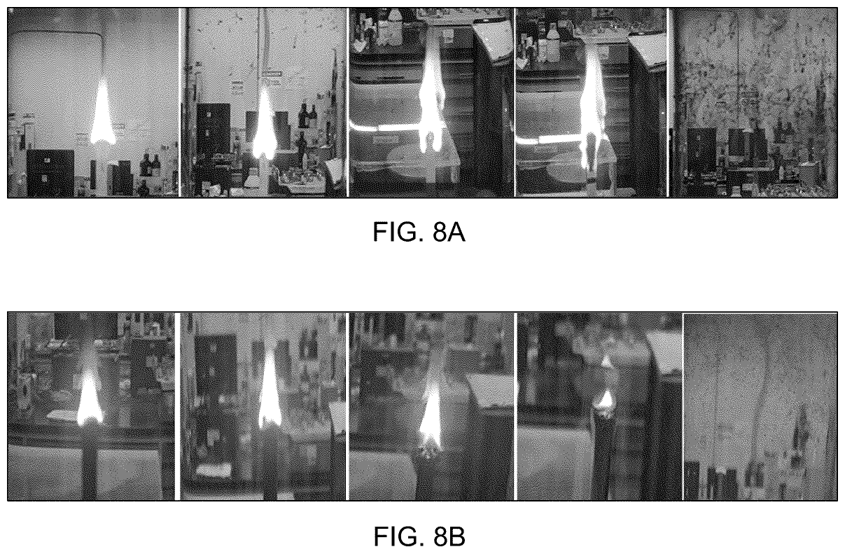

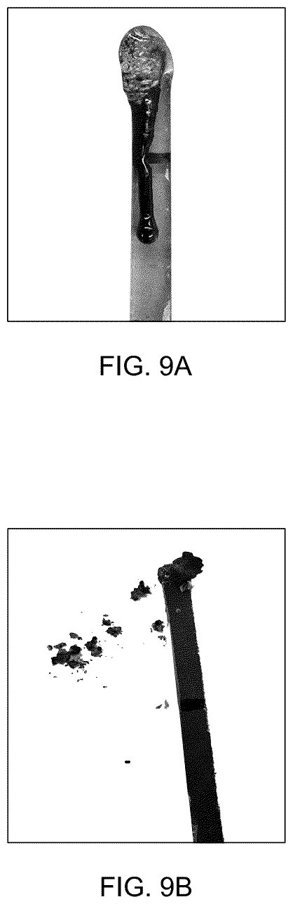

The combustion behavior of the pure PS and its composite over a period of time are depicted in FIG. 8A & FIG. 8B, respectively. The pure PS underwent rapid and vigorous combustion upon exposure to a flame and burned continuously with excess smoke generation for 40 seconds without self-extinguishing. However, the PS composite burned gently after being exposed to flame for a period of time, with less smoke generation, and it self-extinguished after 40 seconds. The PS showed a higher dripping nature, as can be observed in FIG. 8A and =FIG. 9A. While the presence of ZnAl-G-PCL on the PS matrix withstood ignition sources for extended durations due to its robust char-forming capability, as shown in FIG. 8B and FIG. 9B. In comparison with pure PS with its composite, the ZnAl-G-PCL showed a complete char residue. In short, the flammability of the PS was greatly decreased. Therefore, ZnAl-G-PCL fire retardant was used to synergistically retard polystyrene. The presence of graphene in modified LDH, through non-covalent compatibilization, can lead to a prominent fire retardation effect, especially in the suppression of smoke production. The dripping and char generation behavior of PS and PS nanocomposite after combusting for 1 min are depicted in FIG. 9A and FIG. 9B, respectively. Pure PS showed a highly dripping nature, which will lead to fire growth upon fire outbreak. However, the incorporated PS with ZnAl-G-PCL has generated char, which gives the composite the self-extinguish behavior.

### Example 11: Mechanical Analysis

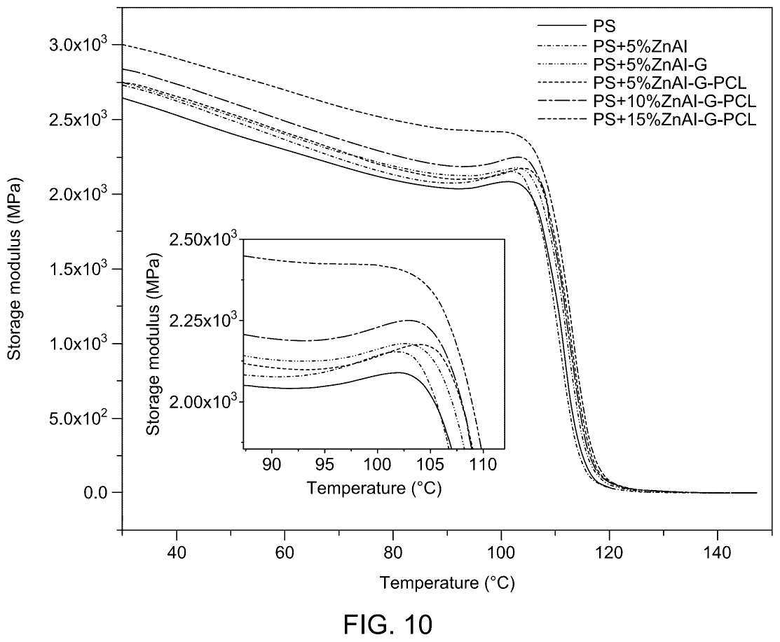

Dynamic mechanical analysis was conducted to assess the viscoelastic behavior of PS and its nanocomposites, PS/ZnAl, PS/ZnAl-G, and PS/ZnAl-G-PCL, across a temperature range from room temperature to 140° C. The mechanical properties of polystyrene and its composites play a role in determining their practical utility. Typically, an increased loading quantity and poor interfacial compatibility between the filler and polymer matrix can result in a degradation of the composite's mechanical performance. The adjustment of storage modulus, loss modulus, and damping factor within this temperature range are depicted in FIGS. 10, 11, and 12, respectively.

FIG. 10 illustrates the changes in the storage modulus across these temperatures. It shows a decrease in the storage moduli of PS and its composites with an increase in temperature, attributed to the phenomenon of energy dissipation involving coordinated movements of the polymer chains as temperature rises. However, the incorporation of LDHs and their hybrids into the PS matrix led to an elevation in the storage modulus throughout the entire temperature spectrum. At the glassy state temperature of 40° C., where molecules are frozen, the addition of 5 wt. % of ZnAl, ZnAl-G, and ZnAl-G-PCL resulted in an enhancement of the storage modulus by 119, 160, and 248 MPa, respectively. This improvement was attributed to the reinforcement provided by the LDHs layer, which improved the interfacial interaction between the filler and the polymer matrix, thereby restricting the mobility of the polymer chains. In general, the incorporation of ZnAl-LDH into the PS matrix positively influenced the storage modulus. However, the modified LDH demonstrated a more pronounced impact on the storage modulus due to its higher compatibility with the PS matrix compared to pristine ZnAl-LDH. Specific values of the storage modulus parameters of ZnAl-LDH pristine and its composites are detailed in Table 2.

TABLE 2
Storage modulus of PS and its composites

Storage Modulus (MPa)

| Sample | 50° C. | 100° C. |
|---|---|---|
| PS | 2400 | 2000 |
| PS/5% ZnAl | 2495 | 2150 |
| PS/5% ZnAl-G | 2525 | 2170 |
| PS/5% ZnAl-G-PCL | 2559 | 2210 |
| PS/10% ZnAl-G-PCL | 2714 | 2334 |
| PS/15% ZnAl-G-PCL | 2853 | 2518 |

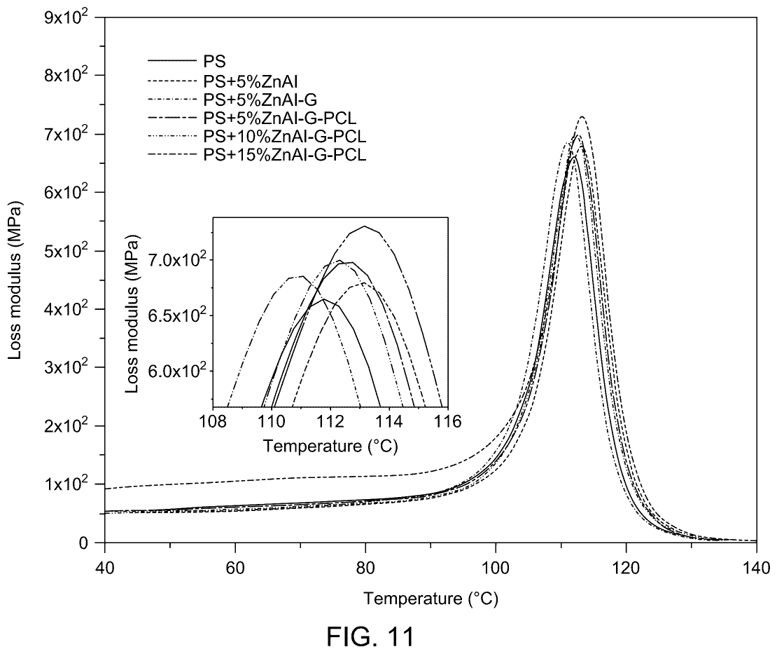

FIG. 11 showcases the loss factor curves for both pure PS and its composites. The temperature corresponding to the peak of the curve represents the glass transition temperature (Tg). In comparison to pure PS, the Tg of the PS/LDHs nanocomposites exhibited a substantial increase. The Tg of the nanocomposites was approximately 158° C. higher than that of the neat PS. The relatively uniform dispersion of LDH layers within the nanocomposites enhances the interfacial interaction between the sheets and the polymer matrix, thereby significantly restricting the segmental motion of polymer chains. This restriction contributes to the noticeable increase in the shift of the Tg. Furthermore, an increase in loss modulus was observed upon introducing 5 wt. % of ZnAl-LDH pristine and its composites. This increase could be attributed to an expansion of the amorphous region, resulting in a reduction in crystallinity. The loss modulus of the nanocomposites surpasses that of pure PS, indicating the role of LDH in decreasing the crystallinity of PS.

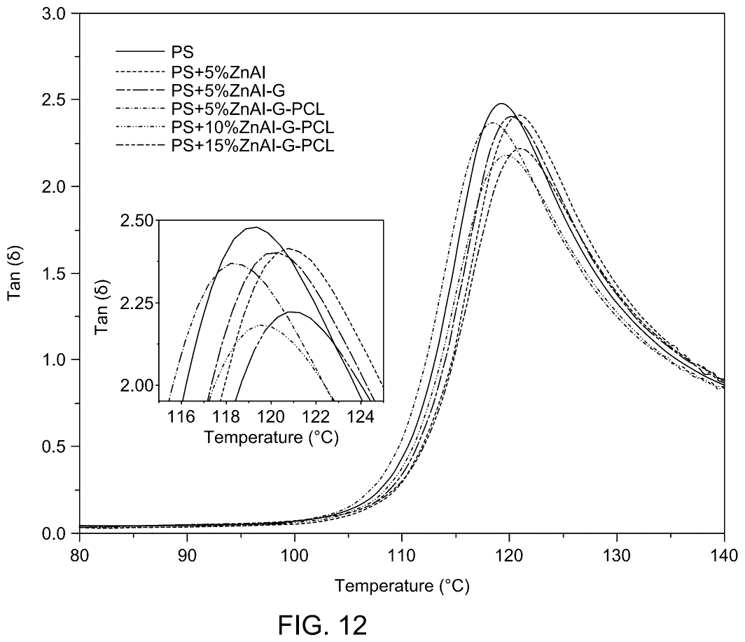

FIG. 12 shows the damping factor tan (8) on temperature curves for pure PS and its nanocomposites. Notably, pure PS exhibits a higher loss factor. However, the addition of ZnAl-LDH pristine and its composites results in a decline in the damping factor. This decrease was ascribed to the effective interaction between PS and LDH phases, promoting increased physical intertwining among the macromolecules. The peak within the tan (8) curve, observed between 115-125° C., corresponds to the glass transition of the PS matrix. This value represents a balance between the elastic and viscous phases within the polymer's structure. Notably, the addition of reinforcements to PS nanocomposite films results in lower damping factors compared to pure PS. Incorporating ZnAl-LDH composites into the PS matrix further reduced the relaxation process. This alteration arises from a reduction in the matrix material responsible for the material's damping properties. Consequently, there is a decrease in the mobility of units involved in the relaxation process due to the restricted movement of polymer molecules constrained by the hydrogen bonds between PS chains, ZnAl-LDH, ZnAl-G, and ZnAl-G-PCL. The unique interactions between polymer chains and filler particles led to a distinct polymer layer around each particle, differing from the bulk material. In this scenario, assuming the particles in the dispersed phase are rigid, the stationary polymer layer contributes to the effective filler volume fraction in the composite. Improved interfacial adhesion is indicated by reduced energy dissipation at the interface, resulting in lower tan (8) peak values.

### Example 12: Thermal Conductivity

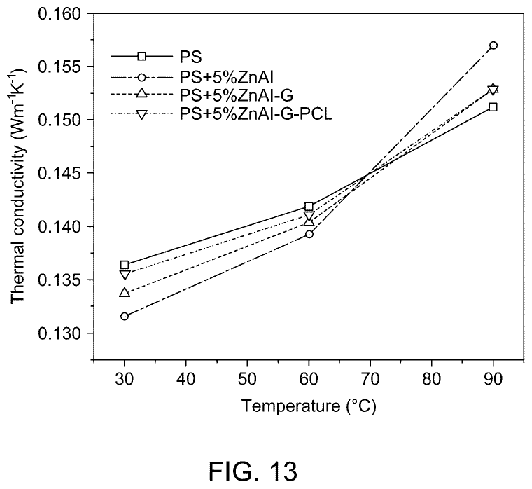

Thermal conductivity is a parameter for assessing the thermal insulation capability of energy-efficient building materials. FIG. 13 illustrates the thermal conductivity of pure PS and its composites across various temperatures. Generally, PS exhibits lower thermal conductivity compared to many polymers, making it an effective thermal insulator. The trend observed in FIG. 12 shows a linear increase in thermal conductivity for both PS and its composites with rising temperature. At a lower temperature of 30° C., the thermal conductivity values for PS, PS+5% ZnAl, PS+5% ZnAl-G, and PS+5% ZnAl-G-PCL are 0.1364, 0.1316, 0.1337, and 0.1356 W/mK respectively. However, at higher temperatures around 90° C., the thermal conductivity rises to 0.1512, 0.1570, 0.1529, and 0.1529 W/mK for PS, PS+5% ZnAl, PS+5% ZnAl-G, and PS+5% ZnAl-G-PCL respectively. This indicates that at higher temperatures, ZnAl-LDH exhibits higher thermal conductivity. This higher conductivity was ascribed to the predominant heat conduction within the solid framework of ZnAl at elevated temperatures. However, the incorporation of graphene and PCL effectively reduces thermal conductivity. The porous nature of graphene and the PCL contribute to improved thermal insulation for PS. Notably, factors like pore structure influence the thermal insulation properties. The reduced pore size and the continuous three-dimensional porous structure of ZnAl-G and ZnAl-G-PCL elongate the heat conduction path, leading to lower thermal conductivity, thus enhancing flame resistance.

Numerous modifications and variations of the present disclosure are possible in light of the above teachings. Therefore, it is to be understood that within the scope of the appended claims, the invention may be practiced other than as specifically described herein.

1: A polymer composite, comprising:
a polystyrene; and
a filler,
wherein the filler comprises:
a layered double hydroxide (LDH);
graphene; and
a phosphonium ionic liquid,
wherein the LDH comprises Zn and Al,
wherein the polymer composite comprises 1-20 wt. % of the filler, relative to a total weight of the polymer composite.

2: The polymer composite of claim 1, wherein the graphene is in a form of graphene nanosheets having an average size of 100-1,000 nm.

3: The polymer composite of claim 2, wherein the graphene nanosheets have a BET surface area of 400-600 m²/g.

4: The polymer composite of claim 1, wherein the graphene and a phosphonium ionic liquid are intercalated between layers of the LDH in the filler.

5: The polymer composite of claim 1, wherein the graphene and a phosphonium ionic liquid replace all water molecules and anions between layers of the LDH in the filler.

6: The polymer composite of claim 1, wherein the graphene is homogeneously dispersed in the filler.

7: The polymer composite of claim 1, wherein particles of the LDH have an average size of 10-70 nm.

8: The polymer composite of claim 1, wherein particles of the LDH have a hexagonal shape.

9: The polymer composite of claim 1, wherein particles of the filler have an average size of 1-20 μm.

10: The polymer composite of claim 1, wherein the LDH, the graphene, and the phosphonium ionic liquid do not interact through covalent bonds.

11: The polymer composite of claim 1, wherein the phosphonium ionic liquid comprises trihexyltetradecyl phosphonium chloride.

12: The polymer composite of claim 1, having a thermal stability up to 400° C.

13: The polymer composite of claim 1, having a higher flame retardancy than the polystyrene alone.

14: The polymer composite of claim 1, having a limiting oxygen index (LOI) of at least 19%.

15: The polymer composite of claim 1, having a storage modulus greater than 2500 MPa at 50° C.

16: The polymer composite of claim 1, wherein the polymer composite is fluorine and bromine free.

17: A method of making the polymer composite of claim 1, comprising:
adding a zinc salt and an aluminum salt to form a first solution;
adding the graphene and a base to form a second solution;
adding a phosphonium salt to a solvent to form a third solution;
adding the third solution to the second solution to form a fourth solution;
adding the fourth solution to the first solution and heating for at least 12 hours to form a reaction mixture;
separating the filler from the reaction mixture; and
adding the filler to a polystyrene to form the polymer composite.

18: The method of claim 17, wherein the third solution comprises the phosphonium salt in an amount of 1-3 times the anion exchange capacity of the phosphonium salt.
